(19) United States
(12) Patent Application Publication
(10) Pub. No.: US 2009/0101059 A1
(43) Pub. Date: Apr. 23, 2009

(54) Solar energy handle for a bicycle

(76) Inventor: Chi-Ching Liu, Yonghe City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/907,970

(22) Filed: Oct. 19, 2007

(51) Int. Cl. F21S 10/00

(52) U.S. Cl. 116/202

(57) ABSTRACT

A solar energy handle for a bicycle is located at a bicycle body and includes a handle body, a solar energy board, a battery set, at least one alarm and a control system. The handle body has a left handle and a right handle. The solar energy board is located at the handle body for absorbing the solar energy and converting the solar energy into electric power. The battery set is connected with the solar energy board for storing the electric power. The alarm is connected with the battery set. The control system is located at the handle body. Thereby, the solar energy is converted into the electric power and is stored in the battery set. The user uses the control system to turn on or turn off the alarm. The power is saved. It is good for the environmental protection, and it is convenient for the user.

### BACKGROUND OF THE INVENTION

1. Field of the Invention

The present invention relates to a solar energy handle for a bicycle. In particular, this invention relates to a solar energy handle for a bicycle that converts the light energy of a natural light into the electric energy and combines with an alarm.

2. Description of the Related Art

The required power of the alarms located at the front side and the rear side of the bicycle or the two sides of the handle usually is provided by a general battery. When a user rides the bicycle at night, the user needs to use the alarm to provide a lighting source or alarm the pedestrians and cars. Thereby, the safety for the rider is improved.

However, the power of the general battery will be exhausted when it has been operated for a period of time or not be used for a long time. If a rechargeable battery is adopted, the cost is increased. Although the rechargeable battery can be detached and recharged by using the household electric power, the user needs to spend money for the household electric power. Furthermore, the rechargeable battery has to often be detached from the bicycle and installed to the bicycle. It is inconvenient for the user. The user may forget to charge the battery or install the charged battery to the bicycle. Because the alarm is not provided with the power, it is dangerous for the user to ride the bicycle at night.

In order to solve the above problem, the developer uses the kinetic power generated by riding the bicycle to charge the rechargeable battery when the rider rides the bicycle. Therefore, the power for the alarm is continuously provided.

However, the described method still has some drawbacks. Although the rechargeable battery can be provided with the electric power when the user is riding the bicycle, the power of the rechargeable battery may be exhausted if the user does not ride the bicycle for a long time. Therefore, if the bicycle is not ridded by the user for a long time, the rechargeable battery cannot obtain adequate power from the kinetic power generated by riding the bicycle.

### SUMMARY OF THE INVENTION

One particular aspect of the present invention is to provide a solar energy handle for a bicycle. It converts the light energy of a natural light into the electric energy, and stores the converted electric power. The user can use a control system to control the alarm. The control system is located at the handle body. The assembling process is simple. It is easy for the user to maintain and replace the solar energy handle for a bicycle. The power is saved. It is good for the environmental protection, and it is convenient for the user.

The solar energy handle for a bicycle includes a handle body having a left handle and a right handle, a solar energy board located at the handle body for absorbing the solar energy and converting the solar energy into electric power, a battery set connected with the solar energy board for storing the electric power provided from the solar energy board, at least one alarm connected with the battery set, and a control system located at the handle body and connected with the battery set. The left handle is connected with the right handle.

The present invention has the following characteristics. The present invention uses the solar energy board located at the handle body to absorb the solar energy and convert the solar energy into electric power, stores the electric power in the battery set, and uses the control system to control and use the alarm. Its structure is simple. It is easy to install and uninstall the solar energy handle for a bicycle. The power is saved. It is good for the environmental protection, and it is convenient for the user.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a perspective view of the solar energy handle for a bicycle of the present invention;

FIG. 2 is an exploded perspective view of the solar energy handle for a bicycle of the present invention; and

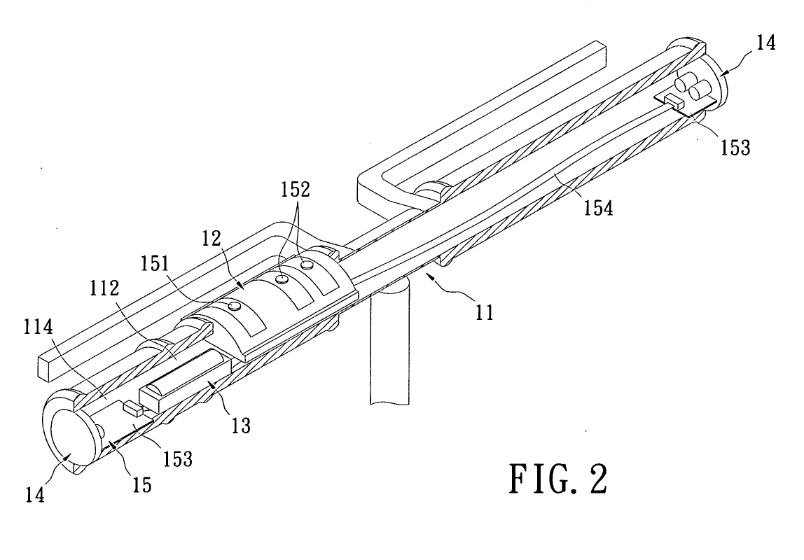

FIG. 3 is a schematic diagram of the usage status of the solar energy handle for a bicycle of the present invention.

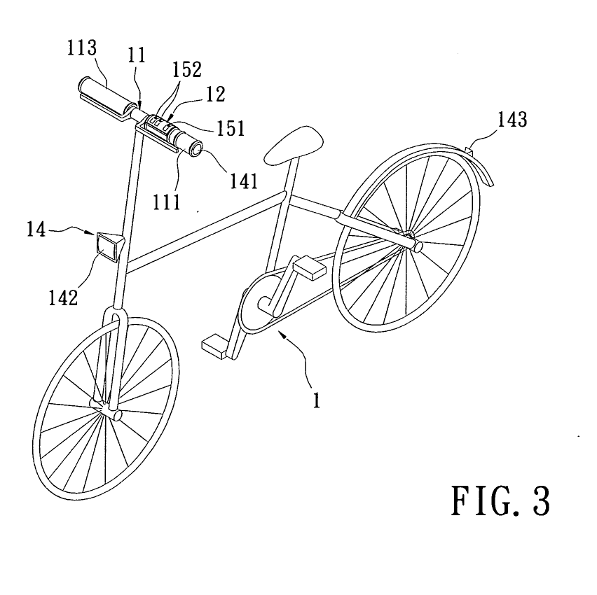

### DETAILED DESCRIPTION OF THE PREFERRED EMBODIMENTS

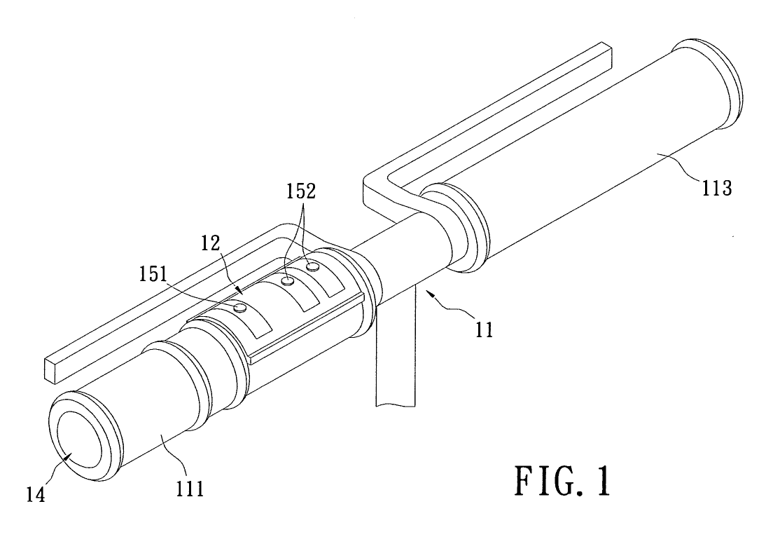

Reference is made to FIGS. 1˜3. The solar energy handle for a bicycle is installed at a bicycle body 1. The solar energy handle for a bicycle includes a handle body 11, a solar energy board 12, a battery set 13, at least one alarm 14, and a control system 15. The handle body 11 has a left handle 111 and a right handle 113. The left handle 111 is connected with the right handle 113. In the handle body 11, there is a first receiving slot 112 and two second receiving slots 114. The first receiving slot 112 is located at one side of the second receiving slot 114. The two second receiving slots 114 are respectively located in the left handle 111 and the right handle 113.

The solar energy board 12 is a rectangular board and is located at the surface of the handle body 11 of the bicycle body 1 for absorbing the solar energy and converting the solar energy into electric power.

The battery set 13 is located in the first receiving slot 112. The battery set 13 is connected with the solar energy board 12 for storing the electric power provided from the solar energy board 12.

In this embodiment, there are four alarms 14. The alarm 14 is a light emitting diode. The alarm 14 may be other lighting device. The four alarms 14 are respectively connected with the battery set 13. The four alarms 14 include a head lamp 142, a paddy lamp 143, and two direction lamps 141. The head lamp 142 is located at the front side of the bicycle body 1. The paddy lamp 143 is located at the rear side of the bicycle body 1. The two direction lamps are located the end of the handle body 11.

The control system 15 is located at the surface of the handle body 11 and the interior of the handle body 11. The control system 15 is connected with the battery set 13. The control system 15 includes a turn-on switch 151, a direction lamp switch 152, and two control circuit boards 153. The turn-on switch 151 and the direction lamp switch 152 are respectively electrically connected with the two control circuit boards 153. The control circuit boards 153 are located in the second receiving slots 114. The two control circuit boards 153 are connected together via a control line 154.

When the user presses the turn-on switch 151, the control system 15 transmits the signal to the battery set 13 to turn on the head lamp 142 and the paddy lamp 143 located at the front side and the rear side of the bicycle body 1 to illuminate. When the sunlight is adequate in daytime, the solar energy board 12 located at the surface of the handle body 11 absorbs the sunlight and converts the solar energy into electric power, and outputs the electric power to the battery set 13 and stores the electric power for providing the electric power to the alarms 14. When the user presses the direction lamp switch 152, the control system 15 transmits the signal to the battery set 13 to light the two direction lamps 141 for alarming the pedestrians and cars.

The present invention uses the solar energy board 12 located at the handle body 11 to continuously provide the electric power to the battery set 13 and stores the electric power for the alarm 14. The present invention also combines the solar energy board 12, the battery set 13, the alarm 14 and the control system 15 on the handle body 11. The assembling process is simple. It is easy for the user to maintain and replace the solar energy handle for a bicycle. The power is saved. It is good for the environmental protection, and it is convenient for the user.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A solar energy handle for a bicycle, located at a bicycle body, comprising:
a handle body having a left handle and a right handle, wherein the left handle is connected with the right handle;
a solar energy board located at the handle body for absorbing solar energy and converting the solar energy into electric power;
a battery set connected with the solar energy board for storing the electric power provided from the solar energy board;
at least one alarm connected with the battery set; and
a control system located at the handle body and connected with the battery set.

2. The solar energy handle for a bicycle as claimed in claim 1, wherein the control system includes a turn-on switch, a direction lamp switch, and two control circuit boards, and the turn-on switch and the direction lamp switch are respectively electrically connected with the two control circuit boards.

3. The solar energy handle for a bicycle as claimed in claim 2, wherein the handle body has a first receiving slot and two second receiving slots, the two second receiving slots are respectively located at two sides of the handle body, the first receiving slot is received with the battery set, the second receiving slots are received with the control circuit boards, and the two control circuit boards are connected together via a control line.

4. The solar energy handle for a bicycle as claimed in claim 1, wherein the alarm comprises two direction lamps, and the two direction lamps are light emitting diode and respectively located at the ends of two sides of the handle body.

5. The solar energy handle for a bicycle as claimed in claim 1, wherein the alarm is a head lamp located at the front side of the bicycle body.

6. The solar energy handle for a bicycle as claimed in claim 1, wherein the alarm is a paddy lamp located at the rear side of the bicycle body.
